(19) United States
(12) Patent Application Publication
(10) Pub. No.: US 2002/0136258 A1
(43) Pub. Date: Sep. 26, 2002

(54) Semiconductor laser pump locker incorporating multiple gratings

(76) Inventor: Dmitry S. Starodubov, Los Angeles, CA (US)

Correspondence Address: FULWIDER PATTON LEE & UTECHT, LLP, HOWARD HUGHES CENTER, 6060 CENTER DRIVE, TENTH FLOOR, LOS ANGELES, CA, 90045, US

(21) Appl. No.: 09/813,514

(22) Filed: Mar. 20, 2001

(51) Int. Cl. H01S 3/08

(52) U.S. Cl. 372/102

(57) ABSTRACT

A series of relatively low reflectivity Bragg gratings are used to stabilize the power and wavelength output of a semiconductor laser. The series of Bragg gratings may be formed in the core of a waveguide, typically either an optical fiber or a planar waveguide circuit, by illuminating the core of the fiber or waveguide through a mask directly through a polymer coating of the fiber or, in the case of a planar waveguide, though the outer layers of the waveguide. The reflectivity of each Bragg grating in the series is less than the reflectivity of the output facet of the laser. The Bragg grating nearest the laser may be located within the coherence distance of the laser. The Bragg gratings may be separated by uniform distance, or the separation between gratings may be non-uniform. Additionally, the gratings may have the same or different periods and reflectivities. The Bragg gratings may be formed in single mode, multimode, polarization-maintaining optical fibers, or other types of optical fibers or solid-state waveguides.

### BACKGROUND OF THE INVENTION

1. Field of the Invention

The present invention relates generally to semiconductor lasers, and more particularly, to systems and method for providing stabilization to optically pumped amplifiers using diode lasers.

2. Description of Related Art

Fiber-coupled semiconductor lasers are widely used in modern telecommunications systems. One of their most important applications is pumping erbium-doped fibers for erbium-doped fiber amplifiers (EDFAs). These optical fiber amplifiers are used to intensify optical signals that are attenuated along the fiber-optic communication path, and have replaced cumbersome electrical repeaters in fiber-optic communication links.

Recently, efforts have been made to incorporate semiconductor lasers into planar waveguide circuits. These systems are advantageous because it is possible to incorporate a laser and Bragg grating on a single integrated chip, thus allowing miniaturization of the device.

In a typical application, light of approximately 1550 nanometers (nm) is transmitted along the guided wave portion of a waveguide, typically an optical fiber. Due to attenuation of the light signal along the length of the optical fiber, it is necessary to reinforce or amplify this signal at given intervals along the fiber. In a typical case, a section of the optical fiber is doped with ions of a rare-earth element such as, for example, erbium. The energy structure of the erbium ions is such that signal light with wavelength of approximately 1530-1565 nm can be amplified in the fiber if there are sufficient erbium ions in their excited state. In such a circumstance, light within the same bandwidth entering the optical fiber will experience a net gain, and will exit the fiber with greater power. Excitation of the erbium ion into the proper excited state, so that gain may occur is usually accomplished by exciting (pumping) the erbium ions with light having a

In a typical system, the semiconductor laser is permanently and robustly connected with an optomechanical apparatus to a length of optical fiber, which is in turn connected to the erbium doped fiber in the optical amplifier. The assembly consists of the semiconductor laser, optomechanical apparatus and optical fiber and is typically called a pigtailed diode laser. Presently, many pigtailed diode lasers have undesirable characteristics such as wavelength and intensity instabilities that create noise in the optical pump system. The most troublesome sources of diode laser noise in 980 nm semiconductor lasers are mode-hopping noise, power and wavelength fluctuations caused by unwanted variable optical feedback into the semiconductor laser or changes in temperature or injection currents. The noise is especially detrimental in fiber amplifiers because it increases error in the amplified optical communication signal and detracts from the practicality of these devices.

One method presently used to improve the performance and stability of the semiconductor laser is to provide a fiber Bragg grating in the optical fiber of the laser pigtail. This grating partially reflects light within a defined wavelength range back to the semiconductor laser, causing the output power and the output wavelength of the laser to become more stable. The Bragg grating formed in the optical fiber is typically made to reflect between 2 to 10 percent of the light falling upon it. In order to achieve the required grating reflectivity and bandwidth with a short and uniform grating, the grating must have a relatively large index modulation, which is not easy to achieve using current manufacturing processes.

The behavior of a semiconductor laser undergoing optical feedback is determined by the effect of the grating upon the laser. The reflectivity of the grating as well as its central wavelength and its bandwidth are selected such that the broadband feedback from the semiconductor laser cavity is greater than the feedback from the fiber grating. In this circumstance, the feedback from the fiber grating acts as a perturbation of the coherent operation mode of the laser cavity. This perturbation acts to break the coherence of the laser emission and therefore reduces the noise associated with coherent multimode operation. The fiber Bragg grating effectively locks the laser cavity output to the fixed wavelength of the grating and centers the external cavity multi-longitudinal modes around that wavelength. The presence of the multi-longitudinal modes reduces the magnitude of mode-hopping noise in the laser. This effect is called coherence collapse. In this condition, the central wavelength of emission of the laser remains near the wavelength of maximum reflection from the fiber grating. The semiconductor laser is thus constrained to operate within the grating bandwidth, so that large fluctuations in wavelength of the laser caused by changes in temperature or current are eliminated. Since the reflectivity of the Bragg grating is typically in the range of 2-10 percent, the laser is less perturbed by extraneous optical feedback from reflective components located beyond the fiber grating, provided the extraneous feedback is weaker than that provided by the grating.

A semiconductor laser that is stabilized in the manner described above does not undergo transitions between single longitudinal modes, as does an un-locked laser. Such transitions cause large intensity fluctuations in the output of the semiconductor laser. These mode transitions can be induced by changes in laser injection current or temperature, for example, and are detrimental to the operation of an optical amplifier or fiber laser.

In general, optical fiber that is used in the telecommunications field is generally comprised of an inner core surrounded by a cladding layer. It is well known in the art that the optical properties of an optical fiber may be severely degraded if the fiber is exposed to pulsed ultraviolet light or adverse environmental conditions or if the cladding or core are physically damaged in some manner during routine handling or installation. Accordingly, a layer of polymer coating usually surrounds the cladding of a typical optical fiber used for telecommunications. This coating provides a mechanical shield to the fiber core and cladding and thereby prevents degradation of the core and cladding from damage caused by environmental processes.

Bragg gratings are typically formed in optical fibers by illuminating the fiber from the side using a pattern of ultraviolet light. In general, forming a Bragg grating in an optical fiber requires stripping the ultraviolet absorbing polymer coating from the core and cladding, illuminating the core and cladding with the desired pattern of ultraviolet light to form the grating and then recoating the core and cladding. Unfortunately, the stripping and recoating process typically results in unpredictable loss of mechanical strength and increased brittleness of the fiber. In order to shield the weak section of the fiber, a protective structure must be formed around the fiber, thus preventing the fiber from being easily rolled into a coil.

Another disadvantage of present methods of providing fiber Bragg gratings to stabilize semiconductor lasers is that the distance of the Bragg grating from the semiconductor laser is typically chosen to be longer than the coherence length of the laser in order to make the reflected light incoherent. However, such a design has certain disadvantages. The Bragg grating formed in the optical fiber and the laser are typically separated by a distance of typically one meter or longer to ensure coherence collapse operation. Accordingly, there is a long dangling piece of optical fiber between the grating and the semiconductor laser, which may be difficult to handle.

Moreover, the long length of optical fiber between the Bragg grating and the semiconductor laser can induce random changes in the polarization of light passing through it. The polarization changes are the result of random birefringence in the fiber caused by bending or by random stress induced in the fiber. These polarization changes in the light reflected back into the semiconductor laser may cause the semiconductor laser to become unstable, thus defeating the purpose of including the fiber Bragg grating in the pigtailed laser.

One method typically used to eliminate random polarization changes of light in the optical fiber between the Bragg grating and the semiconductor laser has been to use polarization-maintaining fiber, such as is made and distributed under the trade name PANDA by Fujikura Ltd. However, such polarization-maintaining fiber is difficult to splice and must be carefully aligned with the semiconductor laser, which is a tedious process. Moreover, a Bragg grating formed in a polarization-maintaining fiber will have two reflections, one for each polarization of light in the optical fiber, which is undesirable. Therefore, the grating should be formed in a separate piece of polarization-insensitive fiber that is then spliced to a polarization-preserving fiber. A disadvantage of this approach is that the splice will decrease the optical output power of the semiconductor laser and further decrease the mechanical reliability of the optical fiber.

What has been needed, and heretofore unavailable, is a system and method of providing Bragg gratings in an optical waveguide for coupling to a semiconductor laser that increases the stability of the laser while not deteriorating the mechanical reliability of the optical waveguide. Such a system should be easy and cost effective to manufacture and provide excellent reliability of the waveguide, even if the waveguide is coiled or bent, while ensuring the stability of the output of the coupled semiconductor laser.

### SUMMARY OF THE INVENTION

Briefly, and in general terms, the present invention provides an apparatus for stabilizing the output power and wavelength distribution of a semiconductor laser used as the pump in an optical amplifier to amplify light transmitted in a telecommunications waveguide, typically an optical fiber, although other types of optical amplifiers and solid state waveguides may also be used and are intended to be within the scope of the present invention. The novel construction of the invention also provides for improved mechanical reliability and protection against the effects of random birefringence in the waveguide. The present invention is also advantageous in that it allows for fabrication of the apparatus without the need for stripping and re-coating of the protective polymer layer of an optical fiber, and further allows the apparatus, when formed in an optical fiber, to be tightly wound on a spool, allowing the apparatus to be mounted within the package of the semiconductor laser.

The apparatus of the present invention comprises a series of Bragg gratings that are formed in the core of an optical fiber or waveguide. This apparatus is optically coupled to a laser, usually a semiconductor laser, having an output facet. Each of the Bragg gratings in the series may have a reflectivity that is less than the reflectivity of the output facet of the laser. Light emitted by the laser into the coupled optical fiber is partially reflected back towards the semiconductor laser by each grating in the series of gratings. Even though the reflectivity of each individual grating is less than the reflectivity of the output facet of the laser, the light reflected by each grating combines to have sufficient reflected light to provide optical feedback to the laser to stabilize the output power and wavelength of the laser.

In one embodiment of the present invention, the series of Bragg gratings begins within the coherence length of the laser. Alternatively, the series of Bragg gratings may begin at a location in the fiber beyond the coherence length of the laser.

In another embodiment of the present invention, the series of Bragg gratings are formed in the core of the optical fiber by illuminating the optical fiber from outside the fiber with ultraviolet light filtered using an appropriate mask. In this manner, the Bragg gratings may be formed in the core portion of the optical fiber without removing the protective polymer layer of the optical fiber. Alternatively, the grating could be formed in a portion of the waveguide structure that is different from the core. For example, the grating could be formed in the portion of the cladding near the core. Manufacturing the Bragg gratings in this manner ensures that the core or cladding layers of the optical fiber are not exposed to the environment, and also eliminates the need to re-coat the optical fiber, which can lead to increased brittleness at the location of the grating with subsequent mechanical failure of the fiber. Moreover, because flexibility of the optical fiber at the location of the grating is maintained, the optical fiber may be tightly wrapped around a spool without fear of mechanical damage to the fiber and to the grating. The gratings may be formed in single-mode, multi-mode, or polarization-maintaining fibers, or they may be formed in other types of solid-state waveguides, such as planar waveguide circuits.

Depending on the needs of the designer of the system, the present invention includes embodiments wherein a uniform distance separates each grating in the series of gratings, or different distances may separate the gratings; alternatively, some of the gratings may be uniformly separated and some may not be uniformly separated in the same series. Typically, an embodiment of the present invention will have three to six gratings formed in the optical fiber, although more than six gratings may also be used, depending on design and operational requirements, and the gratings will be separated 0.1 millimeters to 1.0 meter, preferably 1.0 cm to 10.0 cm. Additionally, each grating in the series may have the same period and wavelength, or they may have different periods or wavelengths, or one or more of the gratings in the series may be chirped.

In another embodiment of the invention, the pump laser and locker of the present invention may be fabricated as part of a planar waveguide circuit. In this embodiment, the laser is formed on a substrate and coupled to a planar waveguide. A series of relatively low reflectivity Bragg gratings are formed in the planar waveguide to reflect light back toward the laser to provide optical feedback to the laser. Alternatively, the pump laser may be separate from the planar waveguide circuit incorporating the pump locker of the present invention, with light from the pump laser suitably coupled to the pump locker in the planar waveguide circuit.

Other features and advantages of the present invention will become more apparent from the following detailed description, taken in conjunction with the accompanying drawings, which illustrate, by way of example, the principles of the invention.

### BRIEF DESCRIPTION OF THE DRAWINGS

FIG. 1 (Prior Art) is a schematic representation of a semiconductor laser associated with a fiber amplifier according to the prior art.

FIG. 2 (Prior Art) is a schematic representation of a fabrication process for forming the fiber grating of FIG. 1.

FIG. 3 is a schematic representation of a semiconductor laser coupled to an optical fiber having multiple Bragg gratings according to the present invention. FIG. 4 is a graph showing the reflection spectrum of a physically short and spectrally wide grating.

FIG. 5 is a graph showing the reflection spectrum of a spectrally narrow grating.

FIG. 6 is a graph showing an example of the reflection spectrum of the multiple Bragg grating design of the present invention.

FIG. 7 is a graph showing the output spectrum of a semiconductor laser without a Bragg reflector.

FIG. 8 is a graph showing the spectrum of a semiconductor laser that is stabilized using the multiple Bragg grating design of the present invention.

FIG. 9 is a schematic representation of a semiconductor laser and the pump locker of the present invention formed as part of planar waveguide circuit.

### DETAILED DESCRIPTION OF THE PREFERRED EMBODIMENTS

The present invention provides a system including multiple Bragg gratings having relatively low reflection coefficients in an optical fiber or solid-state waveguide, whose net effect is to reflect a sufficient amount of light back to a semiconductor laser to provide stabilization for the laser. Also provided is a method for forming the system of the present invention, more specifically, a method for forming Bragg gratings in an optical fiber which ensures that light reflected back to the semiconductor laser is non-coherent and in the desired state of polarization.

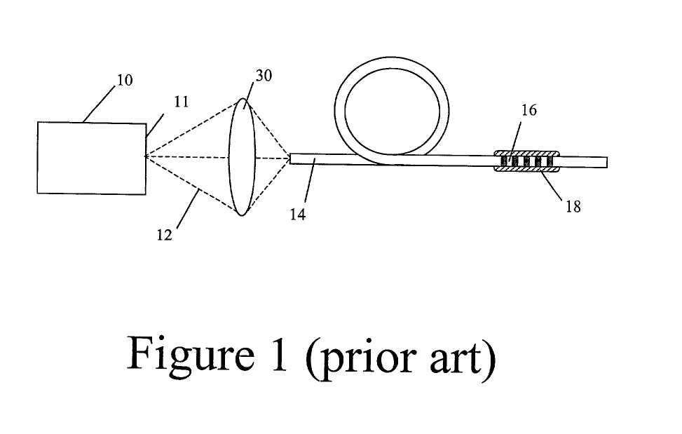

FIG. 1 illustrates a prior art semiconductor laser system that is stabilized using a Bragg grating. In this prior art system, the light output 12 of semiconductor laser 10 is coupled into optical fiber 14 using an optical system 30. A Bragg grating 16 is formed in optical fiber 14 to stabilize the wavelength and output power of the semiconductor laser 10. Typically, the Bragg grating is located approximately 1 meter away from the semiconductor laser 10. In this manner, the Bragg grating is located beyond the coherence length of semiconductor laser 10. This ensures that light reflected back to semiconductor laser 10 is not coherent. In general, the reflectivity of the Bragg grating is in the range of 3 to 10 percent, such that the reflectivity of the Bragg grating is approximately equal to the reflectivity of the output facet 11 of semiconductor laser 10.

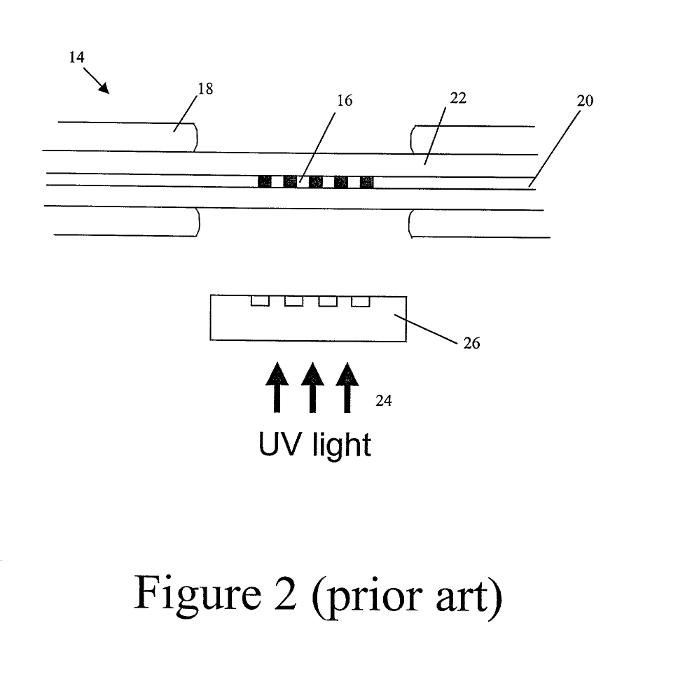

In prior art optical fiber 14, Bragg grating 16 is formed by stripping the polymer coating 18 away from the core 20 and cladding 22 of optical fiber 14 in the area of the optical fiber where the grating is to be located, as illustrated in FIG. 2. After polymer coating 18 has been stripped away from the area of optical fiber 14 overlaying the desired location for the formation of Bragg grating 16, the exposed section of optical fiber 14 is exposed to ultraviolet light 24 through a mask 26 to form Bragg grating 16 in the core 20 of optical fiber 14. Mask 26 is typically a surface relief pattern mask having a spacing calculated to produce a Bragg grating in the core 20 of optical fiber 14 having specified parameters such as a specified spacing and reflectivity. This mask could also be a phase mask made using polymer replication techniques well known by those skilled in the art.

Because the cladding and core 20 are directly exposed to ultraviolet light, it is is possible to form a strongly reflecting Bragg grating having a reflectance in the range of 3 to 10 percent in the core 20 of optical fiber 14. Unfortunately, stripping the polymer layer 18 away from the cladding layer 22 reduces the strength of the fiber and exposes the cladding to the environment, which may result in contamination of the cladding layer. This contamination may cause unwanted changes in the optical properties of the cladding. Further, the exposed portion of cladding 22 must be re-coated with polymer to prevent further alteration of the core and cladding or damage from the environment. When the cladding 22 is re-coated by polymer 18, however, the area of the optical fiber where polymer layer 18 was stripped away is typically more brittle than the continuous layer of polymer 18 covering optical fiber 14. This increased brittleness may result in mechanical failure of the fiber during handling, and may prevent optical fiber 14 from being wound on a spool.

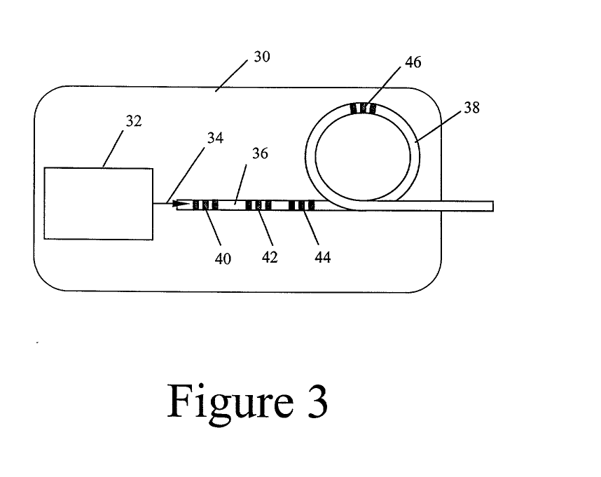

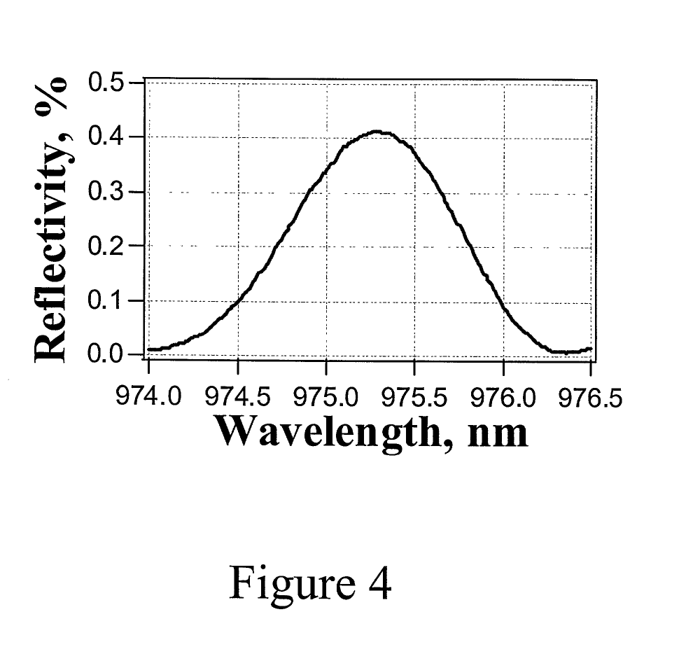

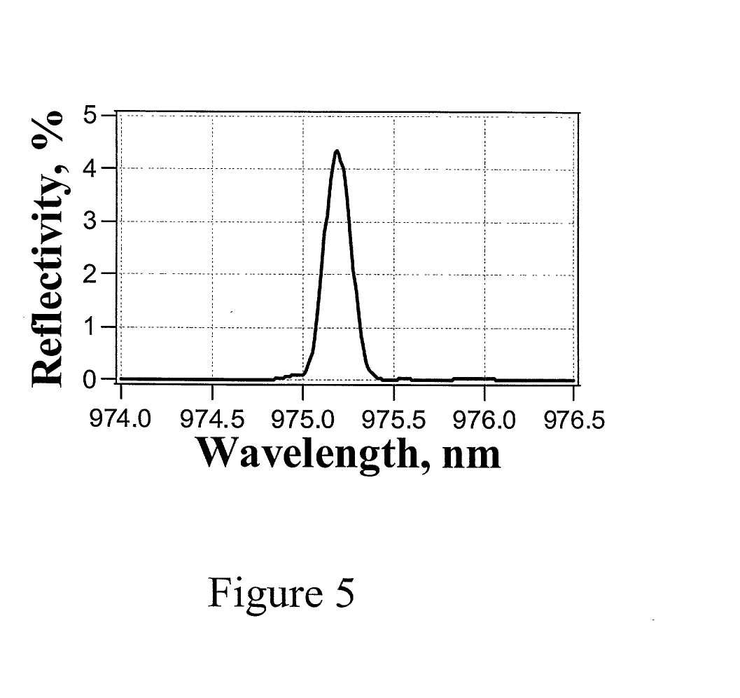

As shown in FIG. 3, the present invention includes incorporating a series of Bragg gratings having relatively low reflectance into an optical fiber or waveguide. Even though each of the Bragg gratings incorporated into the optical fiber or waveguide have a relatively low reflectance and wide spectral width, the light reflected by each Bragg grating tends to sum in such a way that the overall reflectance of the series of gratings is sufficient to stabilize a semiconductor laser. The optimum reflectivity of a single grating in series of N gratings could be as small as approximately 1/N times the reflectivity of the output facet of the semiconductor laser. Gratings with slightly different wavelengths could be added in a similar way to increase the bandwidth of reflection. As illustrated in FIG. 4, a physically short and uniform grating provides relatively low reflectivity in a broad spectrum. The reflectivity from a single low-reflectivity grating is usually not sufficient for optimum stabilization of a semiconductor laser. A physically long grating provides high reflectance in a narrow spectrum, as shown in FIG. 5. In the case of a long uniform grating, however, the bandwidth of the grating is too narrow for optimum stabilization. Using long gratings with small variations of period is not desirable since the grating becomes sensitive to bending and it is difficult to reproducibly control the spectral shape of the reflected light.

The present invention takes advantage of the summation of a series of short, low reflectivity Bragg gratings to provide the same stabilization provided by the single high reflectance gratings of the prior art. Moreover, the present invention provides this stabilization without the disadvantages inherent in the manufacturing process that is used to form the prior art gratings.

Referring again to FIG. 3, in a preferred embodiment of the present invention, a stabilized semiconductor laser assembly 30 is constructed by coupling light 34 from semiconductor laser 32 into optical fiber 36. It should be noted that while an optomechanical coupling system is not shown in this drawing, such systems may be incorporated as is determined to be needed by the designer of the system.

Optical fiber 36 includes gratings 40, 42, 44, and 46 that have been formed in the grating using a method discussed in more detail below. Preferably, the gratings are fabricated by exposing the core and cladding of optical fiber 36 through the coating on the optical fiber.

It is well known in the art that Bragg gratings may be written into the core of an optical fiber that is coated with a polymer that is at least partially transmissive to ultraviolet radiation. The difficulty of using this approach to manufacture the sort of high reflectance Bragg gratings needed for laser stabilization is that the process used to form gratings by exposing the core of the optical fiber to ultraviolet light through the polymer coating results in gratings having relatively low reflectivity, on the order of 0.3-3.0 percent. Such gratings are not optimal for laser stabilization.

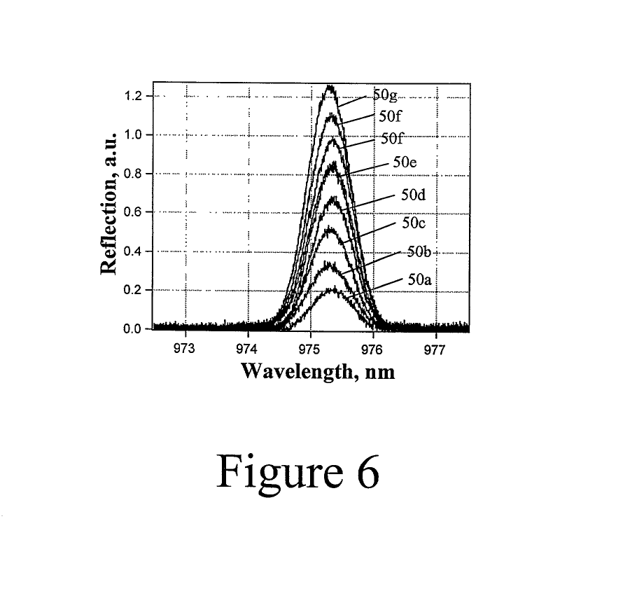

FIG. 6 is a graphical representation of reflectance as a function of wavelength determined for a series of optical fibers 50a-50g having Bragg gratings in accordance with the present invention. Graph 50a was determined for an optical fiber incorporating a single low reflectance Bragg grating formed by illuminating the core and cladding of optical fiber 50a through the polymer coating of fiber 50a with ultraviolet light to form a single Bragg grating having a reflectance of about 0.2 percent. Graph 50b depicts the reflectance graph of an optical fiber incorporating two low reflectance gratings, graph 50c depicts the graph of an optical fiber incorporating three low reflectance gratings and so forth up to graph 50h which depicts the graph of an optical fiber incorporating eight low-reflectance gratings. While the gratings may have small variation of their central wavelengths, all the gratings have approximately uniform periods. The gratings of FIG. 6 are actually chirped with a chirp value as small as ˜0.2 nm/cm.

As is easily seen from an inspection of the graphs shown in FIG. 6, increasing the number of gratings in the fiber optic increases the overall reflectivity of the grating series.

Gratings of the present invention have been fabricated through a standard dual acrylate polymer coating in commercially available photosensitive fiber having a numerical aperture of approximately 0.14. Typically, the splicing loss of such a fiber to Corning 1060 fiber is less than 0.1 dB. The distance between the gratings may be uniform, or non-uniform, and the gratings formed according to the present invention are typically separated by approximately 1 centimeter.

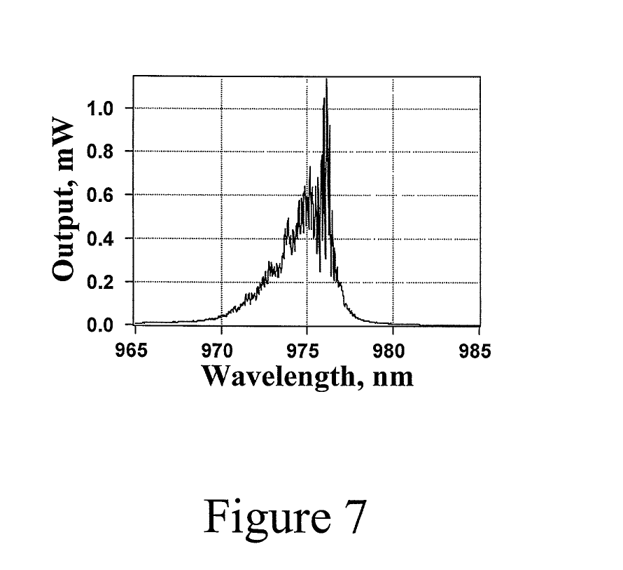

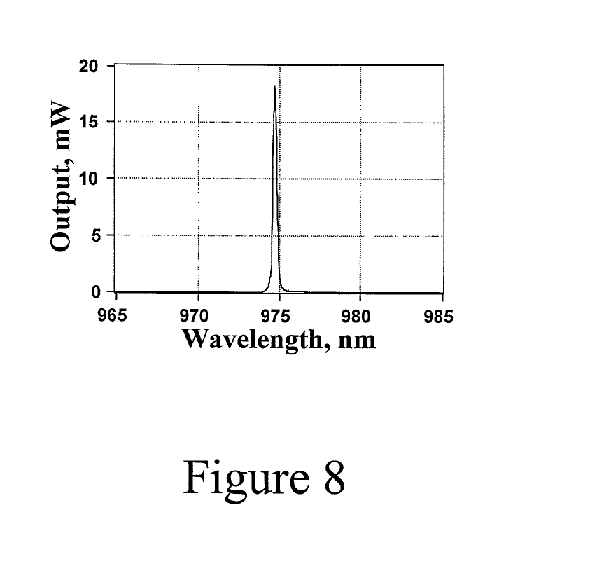

The effectiveness of the fiber Bragg gratings of the present invention is shown by comparing the output wavelength spectra of the two semiconductor lasers shown in FIGS. 7 and 8. FIG. 7 depicts the output spectrum of a semiconductor laser that is not stabilized, and indicates wide fluctuation in both output power and in the distribution of light wavelengths of the laser beam. FIG. 8, in contrast, depicts the output spectrum of the same semiconductor laser that is coupled into the pump locker of the present invention. Not only is the output power of the semiconductor laser stabilized, but, as evidenced by the spectrum depicted in FIG. 8, the distribution of wavelengths around the central wavelength of the laser is much narrower. The measured reflectively of the multiple grating pump locker of the present invention used to produce the output spectrum depicted in FIG. 8 is approximately 7.0 percent.

The configuration of fiber gratings of the present invention has several advantages over prior art systems. For example, as shown in FIG. 3, the first grating in the series may be located much closer to the semiconductor laser than in prior art devices. For example, the first grating in the grating series of the present invention may be located within the coherence length of the semiconductor laser, unlike prior art designs where the grating must be far enough away from the output facet of the semiconductor laser so that light reflected by the grating causes coherence collapse. Moreover, because the polymer coating of the fiber does not need to be removed to form the grating in the optical fiber 36 of FIG. 3, no reinforcement of the polymer coating or fiber is required after the formation of the Bragg grating. Because no reinforcement is required, the length of fiber between the semiconductor laser and the last grating in the series is mechanically strong and may be compactly packaged. For example, it may be wound on a spool 38 having a relatively small radius. Because of the ability to wind the fiber around spool 38 into a tight radius without inducing mechanical failure in the fiber, in some cases the pump locker of the present invention may even be placed within the semiconductor laser package 30.

Returning to FIG. 3, the optimum separation distance between adjacent gratings 40, 42, 44, and 46 may range from a few millimeters to more than 10 centimeters. In general, the grating separation should usually be much larger than the length of the grating. Additionally, while the gratings of the present invention may be spaced uniformly along the fiber, alternatively, the grating separation may also vary. The number of gratings in a series is typically from two to more than ten, preferably three to six.

The gratings in the series may be formed to have the same reflectivity and similar central wavelengths. Alternatively, the gratings in the series may be formed to include a variety of reflectivities, as well as several different central wavelengths, or a distribution of central wavelengths. Furthermore, each individual grating of the present invention may be formed having a uniform spacing, or period, between the lines of the grating, or the grating may be chirped, as that term is known by those skilled in the art of diffraction gratings, to have a non-uniform spacing or period. Typically, the reflectivity for a single grating in the series will range from less than 0.1 percent to approximately 3.0 percent, with total reflectivity of the series being between 0.5-15.0 percent, preferably 2.0-7.0 percent.

Another advantage of the present invention is that the physical separation of the gratings along the fiber reduces the importance of any random birefringence inherent in the fiber or resulting from bending the fiber during handling, such as by winding the fiber in a tight radius around a spool, as is shown in FIG. 3. In prior art designs (FIG. 1), random birefringence in the region between the grating and the semiconductor laser caused by imperfections in the fiber or bending of the fiber causes the polarization of light reflected by the single grating to have an arbitrary state when it returns to the semiconductor laser. In the present invention, however, the light that returns to the semiconductor laser is reflected by a plurality of gratings positioned along the optical fiber. When the length of the array of gratings of the present invention is comparable or longer than the typical distance for polarization changes in the fiber, the reflected light that enters the semiconductor laser contains a mixture of all possible polarizations. In other words, the reflected light becomes essentially unpolarized, thereby canceling the effect of any random birefringence caused by fiber imperfections or handling or bending of the fiber. Accordingly, a pigtailed semiconductor laser incorporating the series of low reflectance gratings of the present invention is less sensitive to random birefringence.

Additionally, the light reflected by the series of gratings locks the output and central wavelength of the semiconductor laser even if the optical fiber is moved, repositioned, or tightly wound around a spool.

Additionally, the bending-induced birefringence in a fiber that is tightly wound on a spool and which incorporates a series of Bragg gratings according to the present invention may serve as a polarization-maintaining fiber for the pump locker and make the locked laser even more stable. This additional benefit results from the compressive stresses that form on the inner portion of the fiber and the tension induced stresses on the outer portion of the fiber when the fiber is tightly wound on the spool, which change the index of fraction of the fiber in those areas. This mimics the distribution of refractive index within a so-called polarization-maintaining fiber, which is typically specifically manufactured to have different refractive indices along different axes. For example, the core of the polarization-maintaining fiber may be shaped ecliptically such that the core has a long axis and a shorter axis, thus providing different refractive indices for the light within the fiber.

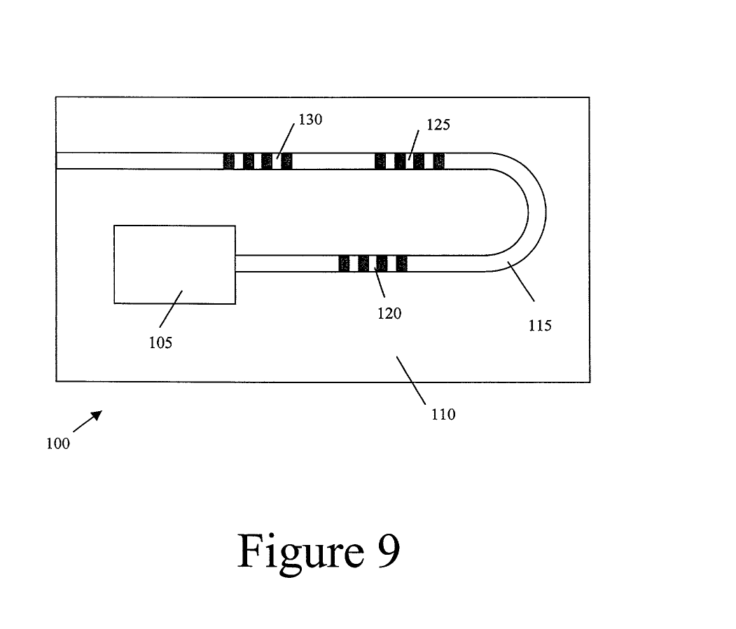

Referring now to FIG. 9, a pump locker according to the present invention may also be incorporated into solid-state devices such as a planar waveguide circuit 100. Such a circuit incorporates a semiconductor laser 105 formed on a substrate 110. The output of laser 105 is coupled into a waveguide 115 that is also formed on the substrate. Such planar waveguide circuits, and methods for forming the components of such, are well known in the art. To ensure that the output of the semiconductor laser is within the desired wavelength and power specifications, a series of relatively low reflectivity Bragg gratings 120, 125 and 130 are formed in the waveguide. The gratings 120, 125 and 130 reflect a portion of the output light back towards the laser 105 to provide optical feedback to the laser, thus stabilizing the output of the laser 105 as described above. The number of gratings, their reflectivity and periods, central wavelengths, as well as the separation between gratings, may be varied as described above with respect to multiple Bragg gratings of the present invention formed in an optical fiber.

The present invention is advantageous in that it can be used to stabilize semiconductor lasers coupled to fibers where it is difficult to form fiber gratings using the methods described in the prior art. For example, the multiple grating pump locker of the present invention may be fabricated in either single mode, multimode, multimode gradient index or polarization-maintaining fiber. The gratings of the present invention may also be formed in the core of double-clad optical fibers. Additionally, the pump locker of the present invention may be used to couple a multimode laser into various types of fibers.

Another example illustrating the usefulness of the multiple gratings of the present invention is use of the pump locker to stabilize the optical output of a fiber laser used as a pump for Raman amplification.

Another use of the present invention is for stabilization of semiconductor lasers that are unconventionally coupled into an optical fiber or solid-state waveguide. For example, the pump locker of the present invention may be used where a semiconductor laser is coupled into the side of an optical fiber or solid-state waveguide, such as a planar waveguide circuit, rather than into the end of the optical fiber or solid-state waveguide, as is typically the case.

The methods used to form the multiple gratings of the pump locker of the present invention are also useful in forming specialized gratings to accommodate various design requirements of the network in which the pump amplifier is to be used. For example, the method of forming gratings through the protective polymer coating could be used to form gratings that extend across only a portion of the cross-section of the core of a fiber or solid-state waveguide. Alternatively, the gratings may extend across the entire cross-section of the core or solid-state waveguide. Moreover, the gratings may be formed in the core of the fiber, the cladding of the fiber, or both.

While several specific embodiments of the invention have been illustrated and described, it will be apparent that various modifications can be made without the departing from the spirit and scope of the invention. Accordingly, it is not intended that the invention be limited, except as by the appended claims.

What is claimed:

1. An apparatus for stabilizing the output of a semiconductor laser, comprising:
an optical fiber having a core and a cladding layer and a selected length, the optical fiber also having a first end for coupling to the laser and a second end for coupling to an optical waveguide; a plurality of gratings formed along the length of the optical fiber, each grating separated from the next grating by a predetermined distance, the gratings configured to reflect a portion of light transmitted from the first end of the optical fiber to the second end of the optical fiber back towards the first end of the optical fiber.

2. The apparatus of claim 1, wherein each of the plurality of gratings has the same period.

3. The apparatus of claim 1, wherein each of the plurality of gratings have different periods.

4. The apparatus of claim 1, wherein the distance between each grating in the plurality of gratings is uniform.

5. The apparatus of claim 1, wherein the distance between each grating in the plurality of gratings is non-uniform.

6. The apparatus of claim 4, wherein the distance between each grating is selected from the range 1.0 mm to 1.0 meter.

7. The apparatus of claim 6, wherein the distance between each grating is selected from the range 1 cm to 10 cm.

8. The apparatus of claim 1, wherein each grating has a reflectivity value representing the percentage of light reflected back towards the first end of the optical fiber.

9. The apparatus of claim 8, wherein the reflectivity values of each of the plurality of gratings are approximately equal.

10. The apparatus of claim 8, wherein the reflectivity values of each of the plurality of gratings are different.

11. The apparatus of claim 8, wherein the reflectivity value of at least one of the plurality of gratings is less than or equal to 1.5 percent.

12. The apparatus of claim 8, wherein the total reflectivity of the plurality of gratings is between 1.0 and 15.0 percent.

13. The apparatus of claim 1, further comprising a coupling device attached to the first end of the optical fiber.

14. The apparatus of claim 1, wherein the optical fiber further comprises a protective layer surrounding the core and cladding layer, and wherein the plurality of gratings are formed in the core by exposing the core to light of an appropriate wavelength transmitted through the protective layer of the optical fiber.

15. The apparatus of claim 1, wherein the plurality of gratings is at least three gratings.

16. The apparatus of claim 1, wherein the plurality of gratings is more than three gratings.

17. The apparatus of claim 1, wherein the optical fiber is a multimode fiber.

18. The apparatus of claim 1, wherein the optical fiber is a polarization-maintaining fiber.

19. An apparatus for stabilizing the output of a semiconductor laser, comprising:
means for transmitting light from the laser to an optical fiber;
a plurality of means formed in the optical fiber for reflecting a portion of the light transmitted from the laser back to the laser and for providing optical feed back to the laser, at least one of the means having a reflectivity of less than 3.0 percent.

20. A stabilized source of laser light, comprising:
a semiconductor laser that emits light and which includes a semiconductor lasing cavity and an output facet defining an end of the semiconductor lasing cavity,
an optical fiber including a core portion and a cladding portion and a protective layer surrounding at least a portion of the core portion and the cladding portion;
means for directing the emitted light from the semiconductor laser into the optical fiber;
a plurality of Bragg gratings formed in the core portion of the optical fiber and having a reflection bandwidth and separated from each other by a selected distance, each of the Bragg gratings having a reflectivity less than a reflectivity of the output facet of the semiconductor laser; and
wherein a portion of the emitted light is reflected by the plurality of Bragg gratings and provide optical feedback to the semiconductor laser, thereby stabilizing the output of the semiconductor laser.

21. The stabilized source of claim 20, wherein the optical distance between the exit facet of the semiconductor laser and Bragg grating formed in the core portion of the optical fiber closest to the semiconductor laser is less than the coherence length of the optical output of the semiconductor laser.

22. The stabilized source of claim 20, wherein the optical distance between the exit facet of the semiconductor laser and Bragg grating formed in the core portion of the optical fiber closest to the semiconductor laser is longer than the coherence length of the optical output of the semiconductor laser.

23. The stabilized source of claim 20, wherein the plurality of Bragg gratings are formed in the core portion of the optical fiber by illuminating selected regions of the optical fiber to ultraviolet light through a mask to write the Bragg grating in the core portion of the optical fiber without stripping the polymer layer from the optical fiber in the region of the Bragg grating.

24. The stabilized source of claim 20, wherein at least one of the plurality of Bragg gratings is a chirped grating.

25. The stabilized source of claim 20, wherein the reflectance wavelengths of each of the Bragg gratings is approximately equal.

26. The stabilized source of claim 20, wherein each of the plurality of Bragg gratings has a uniform period

27. The stabilized source of claim 26, wherein each of the plurality of Bragg gratings has a period that is different.

28. The stabilized source of claim 20, wherein the distance between each Bragg grating in the plurality of Bragg gratings is approximately equal.

29. The stabilized source of claim 20, wherein the distance between at least one of the Bragg gratings in the plurality of Bragg gratings and a next adjacent grating is different from the distances between others of the plurality of Bragg gratings.

30. The stabilized source of claim 20, wherein the plurality of Bragg gratings is at least three gratings.

31. The stabilized source of claim 20, wherein the plurality of Bragg gratings is more than three gratings.

32. The stabilized source of claim 20, wherein the optical fiber is a multimode fiber.

33. The stabilized source of claim 20, wherein the optical fiber is a polarization-maintaining fiber.

34. A stabilized source of laser light, comprising:
a laser that emits light and which includes a lasing cavity and an output facet defining an end of the lasing cavity,
an optical fiber including a core portion and a cladding portion;
means for directing the emitted light from the semiconductor laser into the optical fiber;
a plurality of Bragg gratings formed in the optical fiber and having a reflection bandwidth and separated from each other by a selected distance, each of the Bragg gratings having a reflectivity less than a reflectivity of the output facet of the laser; and wherein a portion of the emitted light is reflected by the plurality of Bragg gratings and provide optical feedback to the laser, thereby stabilizing the output of the laser.

35. The stabilized source of laser light of claim 34, wherein at least one of the Bragg gratings is formed in the core of the optical fiber.

36. The stabilized source of laser light of claim 34, wherein at least one of the Bragg gratings is formed in the cladding of the optical fiber.

37. A stabilized source of laser light, comprising:
a semiconductor laser that emits light and which includes a semiconductor lasing cavity and an output facet defining an end of the semiconductor lasing cavity,
an optical fiber including a core portion and a cladding portion and a protective layer surrounding the core portion and the cladding portion;
means for directing the emitted light from the semiconductor laser into the optical fiber;
a plurality of Bragg gratings formed in the optical fiber and having a reflection bandwidth and separated from each other by a selected distance, each of the Bragg gratings having a reflectivity less than a reflectivity of the output facet of the semiconductor laser;
wherein a portion of the emitted light is reflected by the plurality of Bragg gratings and provide optical feedback to the semiconductor laser, thereby stabilizing the output of the semiconductor laser; and
wherein the optical distance between the exit facet of the semiconductor laser and Bragg grating formed in the core portion of the optical fiber closest to the semiconductor laser is less than the coherence length of the optical output of the semiconductor laser.

38. The stabilized source of laser light of claim 37, wherein at least one of the Bragg gratings is formed in the core of the optical fiber.

39. The stabilized source of laser light of claim 37, wherein at least one of the Bragg gratings is formed in the cladding of the optical fiber.

40. A pump locker for semiconductor lasers, comprising:
an optical fiber having a core and a cladding layer coupled to the laser;
a plurality of gratings formed along a length of the optical fiber, each grating separated from an adjacent grating by a predetermined distance, at least one of the gratings having a reflectivity of less than 10.0 percent.

41. The pump locker of claim 40, wherein the reflectivity of at least one of the plurality of gratings is less than 3.0 percent.

42. A device for stabilizing the output of a laser, comprising:
waveguide means coupled to the laser;
a plurality of means formed in the waveguide for providing optical feed back to the laser.

43. The device for stabilizing the output of a laser of claim 42, wherein the waveguide means is an optical fiber.

44. The device for stabilizing the output of a laser of claim 42, wherein the waveguide means is a planar lightwave circuit.

45. The device for stabilizing the output of a laser of claim 42, wherein the laser and waveguide means are part of a planar lightwave circuit.

46. The device for stabilizing the output of a laser of claim 42, wherein at least one of the plurality of means for reflecting has a reflectivity of less than 3.0 percent.

47. The device for stabilizing the output of a laser of claim 42, wherein the plurality of means for reflecting includes at least three Bragg gratings.

48. The device for stabilizing the output of a laser of claim 42, wherein the plurality of means for reflecting includes more than three Bragg gratings.
